(19) United States
(12) Patent Application Publication
(10) Pub. No.: US 2022/0027605 A1
(43) Pub. Date: Jan. 27, 2022

(54) Systems and Methods for Measuring Attention and Engagement of Video Subjects

(71) Applicant: Mach-3D SaRL, Luxembourg (LU)

(72) Inventors: Chandra Olivier De Keyser, Luxembourg City (LU); Alessandro Ligi, Brussels (BE)

(21) Appl. No.: 17/382,304

(22) Filed: Jul. 21, 2021

Related U.S. Application Data
(60) Provisional application No. 63/054,778, filed on Jul. 21, 2020.

(51) Int. Cl. G06K 9/00; G06T 17/00

(52) U.S. Cl. CPC G06K 9/00335; G06T 17/00; G06K 9/00281; G06K 9/00315

(57) ABSTRACT

Systems and methods for electronically tracking attention and/or engagement of individuals viewing and/or participating in multimedia content are disclosed. Exemplary implementations may: receive video of at least one individual during viewing or interaction with media; detect one or more participating conditions in the video, wherein the one or more participation conditions are related to one or more of speaking time, measured emotions, and level of attention associated with the at least one individual; and, for each of a plurality of time markers in the video, calculate a level of engagement (“LOE”) score of one or more of the at least one individuals with the media at the given time marker, the calculating based at least in part on the detected participation conditions.

### CROSS-REFERENCE TO RELATED APPLICATIONS

The present application claims priority to U.S. Provisional Patent Application No. 63/054,778, filed Jul. 21, 2021, the contents of which are incorporated by reference herein in their entirety.

### TECHNICAL FIELD

This disclosure relates generally to technology for electronically tracking attention and/or engagement of individuals viewing and/or participating in multimedia content. More specifically, systems and methods are presented for automatically measuring engagement and collaboration of various individuals with presentations, meetings, videoconferences, and other media.

### BACKGROUND

With the recent successes of chip miniaturization, the capabilities of even handheld computing devices such as smart phones to perform computing- and resource-intensive tasks such as video processing and analytics at a high level of quality have dramatically increased. Additionally, thanks to powerful central processing units (“CPUs”) and graphics processing units (“GPUs”), modern personal mobile devices include powerful software that materially improves video quality using, e.g. optical image stabilization, light correction, high-quality color modification filters, etc.

These improved capabilities are useful in many contexts and to many software applications, including facial recognition and human emotion detection, augmented reality, extended reality, face filters, 3D interactive objects in an augmented reality environment, etc. Such software packages using traditional methods, software, and hardware, have typically been unable to reliably detect facial features, much less engagement, attention, and emotions.

Employers, entertainers, public speakers, conference hosts, and many other types of content providers have an interest in understanding the level of interest and engagement of their audiences with various types of media presented. For example, employers may wish to know how to maximize the effectiveness of team meetings and understand what types of presentations are most effective, among other information. Entertainers and conference organizers can maximize their audience engagement by understanding how particular topics, media, and types of presentation affect audience attention and engagement.

Audience demographics may be measured in terms of age, gender and ethnicity of each participant. Returning participants may be recognized thanks to re-identification, i.e. face matching with a data base of faces of previous participants.

Traditional methods of estimating the effectiveness of media are severely limited in that they rely on very indirect estimation methods such as attendance (which is only loosely correlated to engagement) or surveys, whose accuracy is usually very low—for example because of the self-selection bias of those who respond to such surveys and because audience members are usually disincentivized from providing honest assessments of others' presentations for fear of repercussions or unnecessarily hurting the feelings of the presenter.

According to various implementations of the present invention, passive tracking of indicators of emotional reactions and attention in video data and application of algorithms to assess emotions and attention levels at particular points in time and over the entire course of a particular meeting or piece of media, for individuals and an audience in aggregate, promise to provide valuable insights to content providers. For example, employers and other video conference hosts may maximize the effectiveness of meeting time and presentations by changing the type of presentation or order of presentation to maximize engagement and attention. In some embodiments, adjustments to content may be made in real-time during a presentation.

According to some embodiments, data related to emotion tracking, attention, and speaking time may be aggregated and weighted with each other and/or other factors to calculate a unique engagement score. In some implementations, the engagement score may be further improved using machine learning algorithms and/or user or administrator feedback regarding results.

### SUMMARY

In general, the present disclosure provides systems and methods for measuring attention and engagement of video subjects. The descriptions herein provide an outline of some implementations of systems and methods according to the present inventions. These disclosures are merely exemplary, as many other implementations are possible as one ordinary skill in the art will understand. Likewise, all example calculations, formulas, media presentations types, reports, etc. are merely specific examples of the broader inventive concepts disclosed herein.

### EXPAND AFTER CLAIMS ARE FINALIZED

Other technical features may be readily apparent to one skilled in the art from the following figures, descriptions, and claims. These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a high-level component diagram of an illustrative system according to some embodiments of this disclosure.

FIG. 2 illustrates a high-level block diagram of components and logical modules of an illustrative system according to some embodiments of this disclosure.

FIG. 3 shows an example of detected facial landmarks according to some embodiments of this disclosure.

FIG. 4 illustrates a sample process of detecting and transforming an image of a user's face for the purpose of detecting facial characteristics according to some embodiments of this disclosure.

FIG. 5 illustrates a vector comparison of facial similarities of various input images according to some embodiments of this disclosure.

FIG. 6 represents a flowchart for a method of electronically tracking attention and/or engagement of various individuals viewing and/or participating in multimedia content according to some embodiments of this disclosure.

FIG. 7 represents a flowchart for using a plurality of videos from user devices to calculate levels of engagement of users according to some embodiments of this disclosure.

FIG. 8 represents a flowchart for calculating levels of engagement of a user using video of the user's personal electronic device, according to some embodiments of this disclosure.

### DETAILED DESCRIPTION

Electronic tracking of attention and engagement of consumers of media is desired. Further improvements are desired with respect to detecting, primarily via the face, emotions and engagement among various demographic groups. Further, it is desired that in some embodiments, all or a substantial amount of the computation should take place at a personal electronic device or otherwise on the “edge” in order to improve responsiveness and better enable a real-time effect unhindered by network latencies. In the case where personal data is processed and not stored, enhanced privacy would provide an additional advantage of the invention.

Existing systems are not reliable, do not take into account enough types of data, and/or do not reliably record engagement of individuals having varied demographic backgrounds. In addition, processing and communication overhead often prohibit robust analysis.

Aspects of the present disclosure relate to embodiments that overcome the shortcomings described above. Systems and methods are presented for technology for electronically tracking attention and/or engagement of individuals viewing and/or participating in multimedia content. More specifically, systems and methods are presented for automatically measuring engagement and collaboration of various individuals with presentations, meetings, videoconferences, and other media.

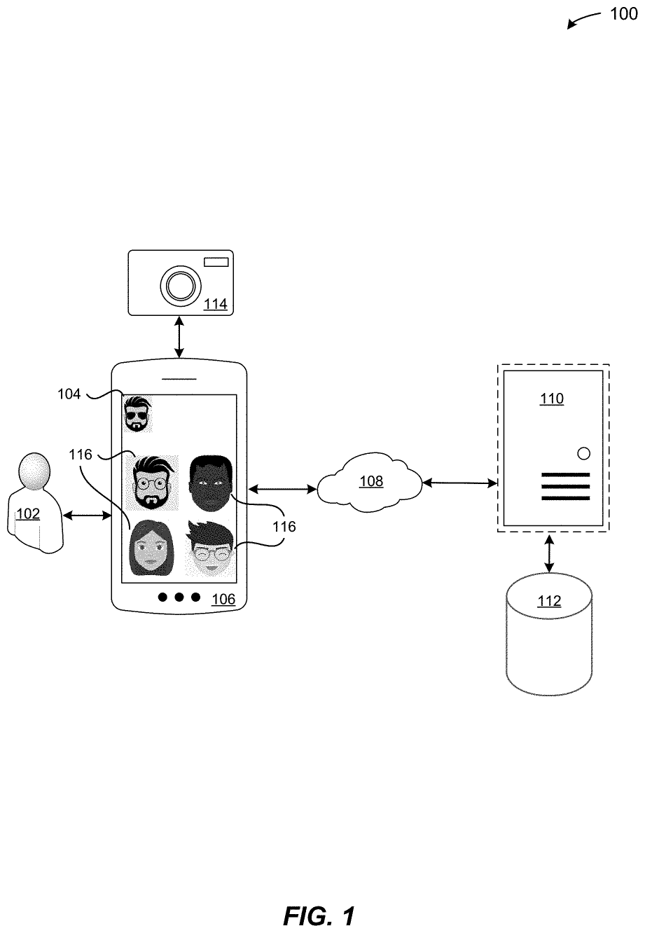

FIGS. 1 through 8, discussed below, and the various embodiments used to describe the principles of this disclosure are by way of illustration only and should not be construed in any way to limit the scope of the disclosure.

FIG. 1 illustrates a high-level component diagram of an illustrative system 100 according to some embodiments of this disclosure. A user 102 interacts with a user device 106. User device 106 may be any suitable computing device, such as a smartphone, tablet, or desktop or laptop computer.

A camera 114 is associated with user device 106. According to some embodiments, camera 114 may be integrated into the device itself. In other embodiments, camera 114 may be an external camera in wired or wireless communication with user device 106.

User device 106 according to some embodiments may also include a user display on which is displayed avatar 104 associated with user 102. According to some embodiments, avatar 104 includes original imagery of the user 102 captured by camera 114.

According to some embodiments, video and/or avatars of one or more additional participants 116 may be displayed on the screen of device 106, for example during a videoconference.

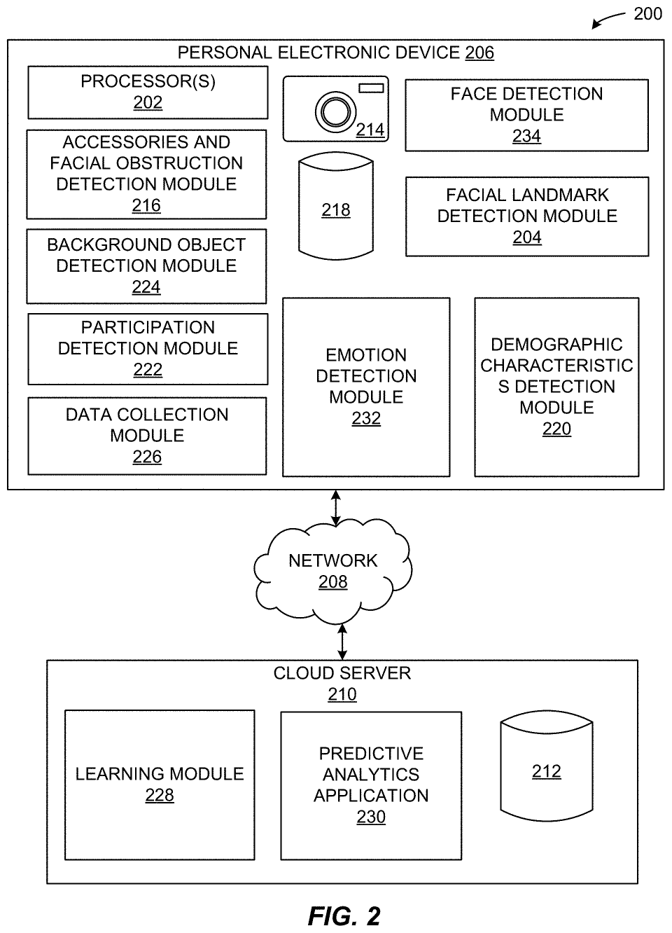

In some embodiments, user device 106 may be connected via a network 108 to a server 110 associated with a datastore 112. In some embodiments, server 110 may comprise a “big data” cloud server for collecting data necessary to run an AI learning capability as will be discussed in greater detail with reference to FIG. 2.

FIG. 2 illustrates a high-level block diagram of components and logical modules of an illustrative system 200 according to some embodiments of this disclosure.

As previously mentioned, in some embodiments, most or all of the calculations necessary to measure engagement (including, e.g., attention, emotions, speaking time, and demographic characteristics) take place on user device 206, which is illustrated at FIG. 2 as a personal electronic device. According to various embodiments, user device 206 includes one or more processors 202 for performing all computations required of the device and a data store 218, which may comprise any combination of appropriate nonvolatile and/or volatile storage media as would be apparent to one having ordinary skill in the art.

Camera 114 according to some embodiments may be integrated into user device 206 or a standalone camera connected to device 206 via a wireless or wired connection. Camera 114 captures video, or a series of images, of at least one user's face and/or body.

According to some embodiments, the video may be analyzed frame-by-frame in substantially real-time, wherein the system for each frame extracts a photograph, regardless of the resolution available, and identifies one or more faces or body parts present in the picture.

According to some embodiments, each frame is then analyzed by face detection module 234 to determine whether one or more faces is present in the frame. According to some embodiments, face detection module 234 may return a rectangle or otherwise indicate an area of the image for each detected face, such information being useful to other modules, for example when it is desirable to apply an effect only to an area of a face or to areas NOT representing a face.

According to some embodiments, if at least one face is detected, facial landmark detection module 204 will then analyze the frame or frames to identify a number of face landmarks or anchors of each face present in the frame. According to some embodiments, facial landmark detection module 204 may detect between 50-150 landmarks for each face, collectively representing a number of features including but not limited to: contour of the lips, nose, eyes, eyebrows, oval of the face, and many other data points as would be apparent to one having ordinary skill in the art. According to some embodiments, facial movements may be tracked by analyzing movements of landmarks with respect to the previous frame. In other embodiments, advanced AI techniques utilizing neural networks or other methods such as machine learning and/or deep learning algorithms may be able to detect emotions without the explicit facial landmark detection.

According to some embodiments, a specialized emotion detection module 232 may be configured to analyze frames of the video stream and detect emotions in the face. According to some embodiments, an artificial intelligence system such as a neural network or other suitable system may be used to perform the emotion detection.

According to various embodiments, demographic characteristics such as age, gender, ethnicity, or other features of the face and/or body may be detected by demographic characteristics module 220. According to some embodiments, this module may also include an artificial intelligence and/or neural network component, or may employ more traditional algorithms

Still further detection may be performed in some embodiments by the accessories and facial obstruction detection module 216. For example, the presence and shape of hair or facial hair may be detected. Accessories such as a hat, glasses, facial jewelry, etc. may also be detected by this module.

According to some embodiments, another such specialized component, the background object detection module 224, may detect additional elements external to the face(s) of the participants. For example, any elements external to the face such as the user's body or a background scene where the face is present may be detected by this module.

Each of these face AI modules described above according to various embodiments may provide data about the characteristics of the detected face or the scene, or emotions or attention of one or more users. All or part of this data may be collected by data collection module 226.

According to some embodiments, a participation detection module 222 may be used to detect participation of various user with a presentation, for example by measuring attention given to the presentation, speaking time of various users, emotions detected on the face, and other relevant parameters as would be apparent to one having ordinary skill in the art. According to some embodiments, a level of engagement score may be calculated based on one or more of these parameters. According to various embodiments, formulas and/or weighting for calculating engagement scores may depend at least in part on the type of presentation and/or demographics of a user. According to some embodiments, formulas and/or weighting for scoring purposes may be at least partially affected and configurable by user preferences, for example the preferences of a content provider or system administrator.

The data supplied by the various modules discussed herein is in some embodiments, then used by module 222, for example as input to algorithmic scoring calculations and/or to personalize and adapt the analysis based on demographic information. According to some embodiments, all processing may happen locally on one or more user electronic devices.

Emotion Detection: in some embodiments, the emotion detection algorithm is based upon deep learning, for example using one or more of several Training Data Bases such as FER 2013: Facial Expression Recognition, RAF: Real Affective Faces.

In some embodiments, the face images of such data bases may be annotated with 7 emotions: happiness, surprise, anger, sadness, disgust, fear & neutral. After training the neural network with appropriate data sets, a process of optimization may be applied to reduce the size of the resulting neural network.

The trained neural network may provide the probability of an image of a face showing given emotions, such as 40% happy, 30% surprise, 20% afraid, etc.

According to some embodiments, the neural network is optimized to run in real time on a target computer such as a mobile phone, with a video stream of up to 30 frames per second, in other words, the processing to compute the emotions takes less than 33 milliseconds.

Attention Detection: according to some embodiments, an attention detection algorithm is based upon a face tracker which computes the 3D face landmarks. In various implementations, a plurality of landmarks is detected, representing facial features such as eyes, nose, mouth, and overall face oval. In one simple implementation, the face orientation determines the level of attention: a head not rotated with respect to the object of attention means maximal attention, and a head fully rotated at 90° means minimal attention. According to some embodiments, a rotation higher than 90° would also mean minimal attention but no face trackers are capable of measuring head rotations >90° as they are all based on the recognition of the face landmarks on the eyes, nose and mouth. In a more elaborate implementation, a gaze tracking algorithm may also be applied, which measures the direction of the eyes, rather than the direction of the head. Both head rotation and gaze can be combined to determine the level of attention.

Speaking time: In order to work across any video tool, the invention may according to some embodiments implement speech detection just by analyzing video images, not by connecting to the video collaboration tool audio data provided by a stream or API. According to some embodiments, an implementation may use the same tracker used for the attention detection to track speaking time. Of the detected 66 landmarks, the algorithm according to some embodiments measures the change of distance between the landmarks of the upper & lower lips over a period of a few seconds, in order to determine whether the person is talking a lot, a little, or not at all.

Face Identification. In some implementations, the system may attempt to recognizing participants in video calls in order to associate engagement data (emotions, attention and speaking time) to the right person. In one implementation, the system applies a face re-identification algorithm to detect if a person present in an image has already been present in previous video calls. This face re-identification algorithm converts any face image into a vector, following the steps described in this figure. The pre-processing steps (detection of bounding box around a face, detection of fiducial points, transformation & cropping) normalize images which are injected in a deep neural network whose output is a representation. According to some implementations, the face identification algorithm uses a 128-dimension vector.

These examples herein should in no way be considered exhaustive, as they are provided solely to show the breadth of the concept of electronically assessing engagement with material.

The capability to detect people's emotions, gender, age and ethnicity face characteristics when they are exposed media enables the system to collect data on their preferences by demographics: by categorizing various types of media and by measuring the emotional reaction of users by age group, gender and ethnicity provides big data that enables to predict future emotional responses of people of any age, gender & ethnicity to other types of media.

To further describe the big data aspect of this invention according to some embodiments, Data Collection Module 226 runs on a user device and collects all the data (provided by the specialized Face AI components) on emotions, gender and age (and possibly more) as well as the type & category of media. Such data is collected locally according to some implementations, and then sent (in real time or asynchronously) via network 208 to a Cloud Server 210 which will store big data coming from possibly a large number of devices on which such Data Collection Modules are running into a database 212.

A learning module 228 may be implemented according to some embodiments on the Cloud Server by running a Predictive Analytics application 230 based on big data AI making use of all the collected data to predict (for instance) what will be the emotional reaction of (for instance) male in the age group 25-35 to a new presenter, visual aid, or presentation style or format.

Collecting such reactions is an important part of the process of improvement according to some embodiments. Going further in the personalization, some embodiments may take advantage of a learning capability based on a big data storage to provide feedback to application(s) on the devices so that it adapts the filter to the age and gender of the person facing the device camera. Suppose, for example, that there was information gleaned from the questions that we learnt that males in the 25-35 age group gave the most positive response PowerPoint presentations. This information, adequately coded, could be useful to content providers in designing their media.

According to some embodiments, all engagement-related data and scores may be captured by Data Collection module 226, for example to facilitate analytics updates.

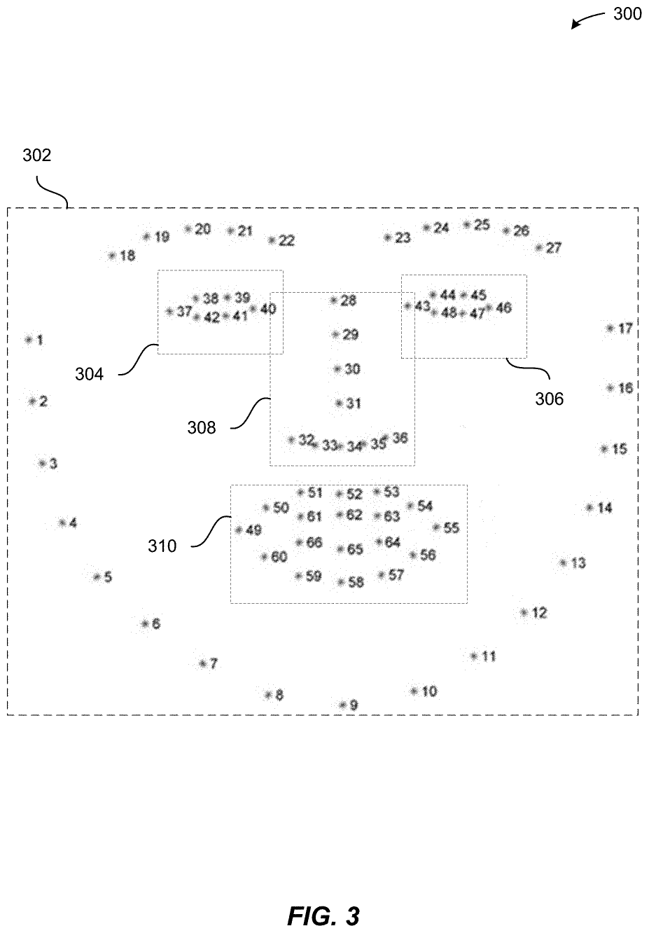

FIG. 3 shows an example of detected facial landmarks in diagram 300 according to some embodiments of this disclosure. At facial detection 302, in the example of FIG. 3, 66 distinct facial landmarks are detected in a user's face. In the illustrative embodiment of FIG. 3, a right eye 304, left eye 306, nose, 308, and mouth 310 are defined by various landmark points.

According to some embodiments, this or similar facial landmark detection may facilitate various functions such as attention detection. According to some embodiments, an attention detection algorithm may be based upon a face tracker using detected landmarks such as those shown at FIG. 3.

In the implementation shown in the diagram at FIG. 3, 66 landmarks are identified as well as the face orientation (rotations around 3 axis). In one simple implementation, the face orientation determines the level of attention: a head not rotated with respect to the object of attention means maximal attention, and a head fully rotated at 90° means minimal attention. According to some embodiments, a rotation higher than 90° would also mean minimal attention but no face trackers are capable of measuring head rotations >90° as they are all based on the recognition of the face landmarks on the eyes, nose and mouth. In a more elaborate implementation, a gaze tracking algorithm may also be applied, which measures the direction of the eyes, rather than the direction of the head. Both head rotation and gaze can be combined to determine the level of attention.

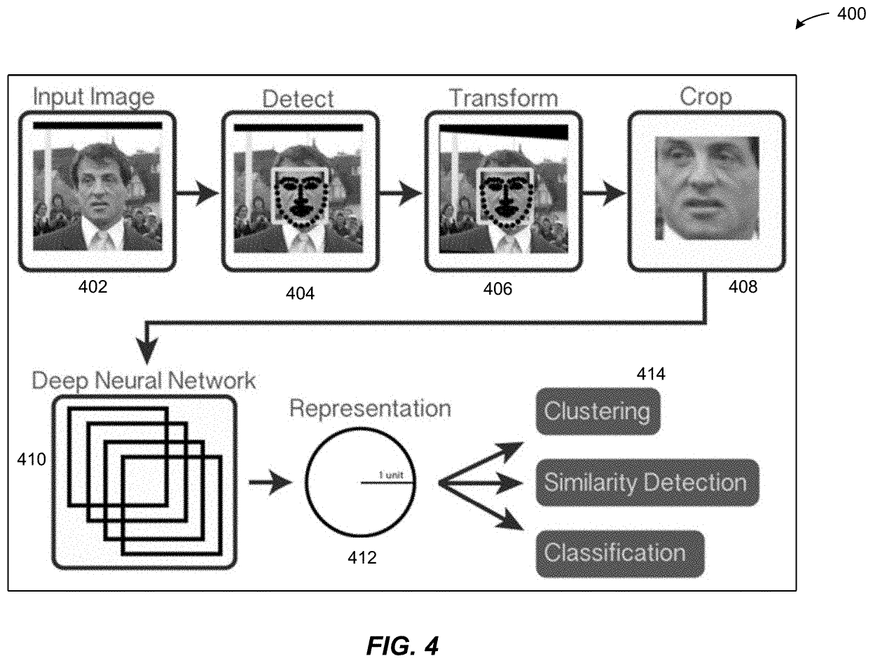

FIG. 4 illustrates a sample process of detecting and transforming an image of a user's face in diagram 400 for the purpose of detecting facial characteristics according to some embodiments of this disclosure.

According to some embodiments, a face-vector transformation may be used to compare similarities between faces. For example an input image 402 may be received, and facial landmarks and other data detected at step 404 according to one or more of the various methods described herein and/or other methods as would be apparent to one having ordinary skill in the art.

According to various embodiments, the input image may be transformed (e.g. to normalize the size and/or face angle for comparison) and/or cropped at step 408 for consistency and efficiency.

According to various embodiments, a deep neural network 410 and/or conventional algorithms may be used to create a vector representation at 412 of the one or more faces of the input image. Various and numerous attributes may be considered in this vector categorization according to specific application and the input data available.

At step 414 one or more further modes of analysis comparing multiple vectors may be applied including clustering, similarity detection, and classification of analyzed faces according to the attributes discussed in more detail elsewhere in this disclosure.

In some implementations, the system may attempt to recognizing participants in video calls in order to associate engagement data (emotions, attention and speaking time) to the right person. In one implementation, the system applies a face re-identification algorithm to detect if a person present in an image has already been present in previous video calls. This face re-identification algorithm converts any face image into a vector, following the steps described in this figure. The pre-processing steps (detection of bounding box around a face, detection of fiducial points, transformation & cropping) normalize images which are injected in a deep neural network whose output is a representation. According to some implementations, the face identification algorithm uses a 128-dimension vector.

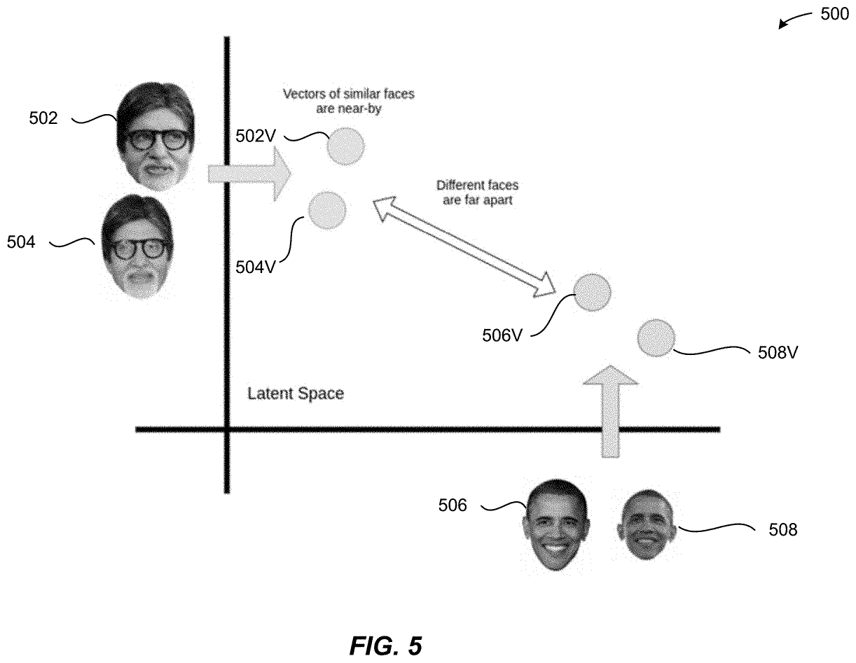

FIG. 5 illustrates a vector comparison 500 of facial similarities of various input images according to some embodiments of this disclosure. In the example of FIG. 5, vector representations of several faces have been developed as described in further detail above. Accordingly, similar faces 502 and 504 are represented by vectors 502V and 504V, respectively, while faces 506 and 508 are represented by calculated vectors 506V and 508V, respectively.

According to various embodiments, vectors of faces that are similar (or, for example, expressing similar emotions) may occupy proximal space to one another, while faces that are dissimilar will be mapped relatively far apart from each other, as shown at FIG. 5.

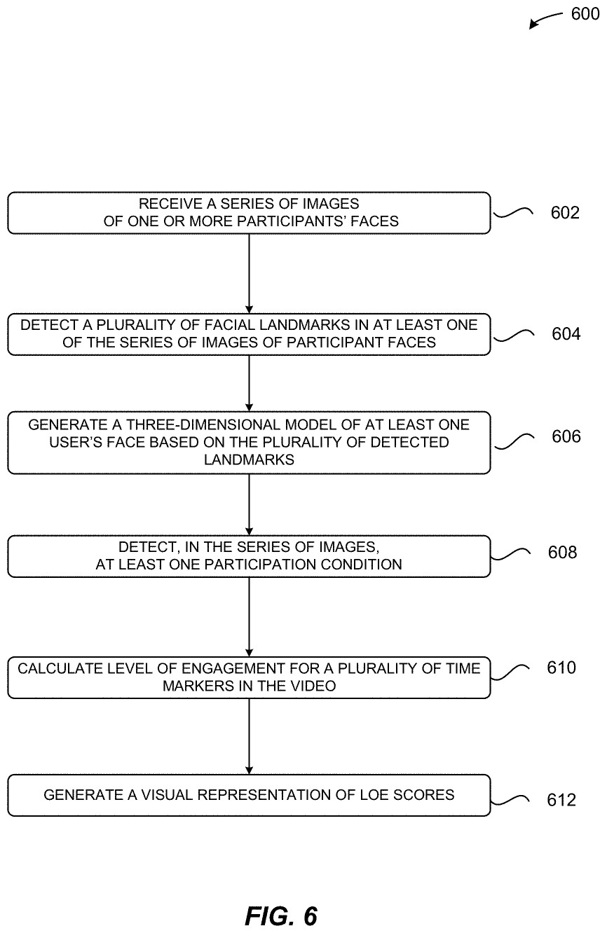

FIG. 6 represents a flowchart 600 for a method of electronically tracking attention and/or engagement of various individuals viewing and/or participating in multimedia content according to some embodiments of this disclosure.

At step 602, a series of images of one or more participants' faces are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video, for example a video of a presenter or multiple video feeds of meeting participants.

At step 604, a plurality of facial landmarks are detected in the series of images of the one or more participants' faces. According to some embodiments, this step may be performed on a user device by a facial landmark detection module or equivalent functionality as described in detail with reference to FIG. 2.

At step 606, a 3D model of at least one user's face is generated based on the plurality of detected landmarks. As with step 604 above, more detail of the step according to some embodiments may be found at detailed description paragraphs above dedicated to FIG. 2.

At step 608 according to some embodiments, at least one participation condition may be detected, for example, as described above with reference to FIG. 2.

At step 610, a level of engagement is calculated at a plurality of time markers. As with other steps, details of this calculation are discussed further above.

At optional step 612, a visual representation of LOE scores may be generated. As just one example, a presenter may be able to view, in real-time and/or as a report after the presentation, a graph of LOE scores of various individuals. In real-time, this information may be used by a presenter to know when to change topics or formats in order to improve audience engagement. In post-presentation analysis, additional improvements to the presentation format and/or media may be made based on this LOE data.

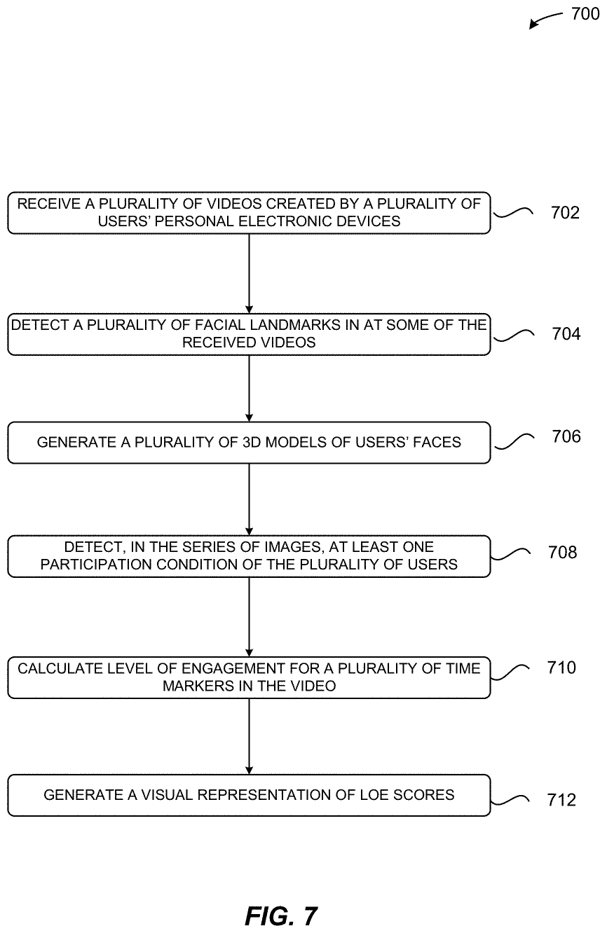

FIG. 7 represents a flowchart 700 for using a plurality of videos from user devices to calculate levels of engagement of users according to some embodiments of this disclosure.

At step 702, a plurality of videos created by a plurality of users' personal electronic devices are received. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a for example a video of a presenter or multiple video feeds of meeting participants.

At step 704, a plurality of facial landmarks are detected in the series of images (video) of the one or more participants' faces. According to some embodiments, this step may be performed on a user device by a facial landmark detection module or equivalent functionality as described in detail with reference to FIG. 2.

At step 706, a 3D model of at least one user's face is generated based on the plurality of detected landmarks. As with step 704 above, more detail of the step according to some embodiments may be found at detailed description paragraphs above dedicated to FIG. 2.

At step 708 according to some embodiments, at least one participation condition may be detected, for example, as described above with reference to FIG. 2.

At step 710, a level of engagement is calculated at a plurality of time markers. As with other steps, details of this calculation are discussed further above.

At step 712 according to some embodiments, a visual representation of LOE scores may be generated. As just one example, a presenter may be able to view, in real-time and/or as a report after the presentation, a graph of LOE scores of various individuals. In real-time, this information may be used by a presenter to know when to change topics or formats in order to improve audience engagement. In post-presentation analysis, additional improvements to the presentation format and/or media may be made based on this LOE data.

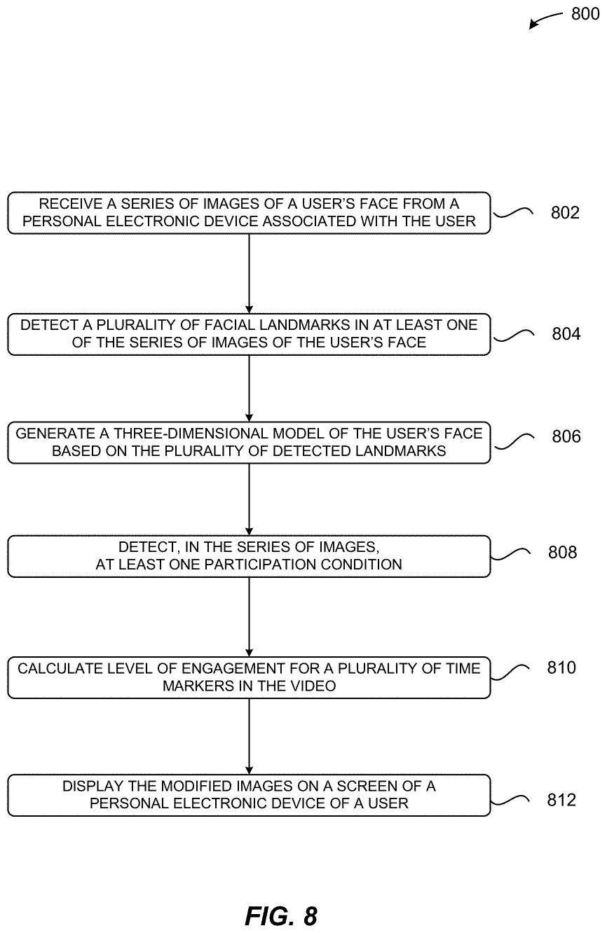

FIG. 8 represents a flowchart 800 for calculating levels of engagement of a user using video of the user's personal electronic device, according to some embodiments of this disclosure.

At step 802, a series of images of a user's face are received from a personal electronic device of the user. According to some embodiments, these may be captured from a camera as described above. According to some embodiments, a user may have his or her face filmed by a camera integrated with or connected to a computer (such as a smartphone or a desktop PC), while the user is viewing a screen associated with the electronic device as the screen displays a video, for example a video of a presenter or multiple video feeds of meeting participants.

At step 804, a plurality of facial landmarks are detected in the series of images of the user's face. According to some embodiments, this step may be performed on a user device by a facial landmark detection module or equivalent functionality as described in detail with reference to FIG. 2.

At step 806, a 3D model of the user's face is generated based on the plurality of detected landmarks. As with step 804 above, more detail of the step according to some embodiments may be found at detailed description paragraphs above dedicated to FIG. 2. According to various embodiments, this generation occurs on the user device.

At step 808 according to some embodiments, at least one participation condition of the user may be detected, for example, as described above with reference to FIG. 2.

At step 810, a level of engagement of the user is calculated at a plurality of time markers. As with other steps, details of this calculation are discussed further above.

At step 812 according to some embodiments, a visual representation of LOE scores may be generated. As just one example, a presenter may be able to view, in real-time and/or as a report after the presentation, a graph of LOE scores of various individuals. In real-time, this information may be used by a presenter to know when to change topics or formats in order to improve audience engagement. In post-presentation analysis, additional improvements to the presentation format and/or media may be made based on this LOE data.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method for assessing engagement of at least one individual with respect to media, the method comprising:
receiving video of the at least one individual during viewing or interaction with the media;
detecting one or more participation conditions in the video, the one or more participation conditions related to one or more of speaking time, measured emotions, and level of attention associated with the at least one individual; and
for each of a plurality of time markers in the video, calculating a level of engagement (“LOE”) score of one or more of the at least one individuals with the media at the given time marker, the calculating based at least in part on the detected participation conditions.

2. The method of claim 1, further comprising generating a visual representation of at least some of the plurality of LOE scores.

3. The method of claim 1, wherein the media comprises a videoconference.

4. The method of claim 1, further comprising calculating a collaboration score, the collaboration score based at least in part on the plurality of LOE scores.

5. The method of claim 4, wherein the collaboration score is further based at least in part on one or more emotion tracking data points.

6. The method of claim 1, further comprising generating an engagement report to be transmitted to the content provider of the media, the engagement report based at least in part on the plurality of LOE scores.

7. The method of claim 1, wherein the LOE scores are calculated by a processor of a mobile device.

8. The method of claim 1, further comprising adjusting content of the media during a presentation of the media, the adjusting based at least in part on the plurality of LOE scores.

9. The method of claim 1, wherein at least one algorithm for calculating LOE scores is adjusted based at least in part on the type of media presented and one or more corresponding LOE scores of individuals viewing the media.

10. The method of claim 1 wherein an aggregate LOE score is calculated at least in part by using data from a plurality of participants, wherein the aggregate LOE score represents data across one or more of various genders, age groups, and ethnicities of individuals viewing the media.

11. The method of claim 10, wherein the aggregate LOE is calculated using data collected across one or more of a specified period of time or a plurality of video sessions.

12. A system comprising:
a personal electronic device operated by a user;
one or more hardware processors of the personal electronic device, the one or more hardware processors configured by machine-readable instructions to:
receive video of the user during viewing or interaction with media;
detect one or more participation conditions in the video, the one or more participation conditions related to one or more of speaking time of the user, measured emotions of the user, and level of attention associated with the user; and
for each of a plurality of time markers in the video, calculating a LOE score of the user with the media at the given time marker, the calculating based at least in part on the detected participation conditions.

13. The system of claim 12, further comprising generating a visual representation of at least some of the plurality of LOE scores.

14. The system of claim 12, further comprising calculating a collaboration score, the collaboration score based at least in part on the plurality of LOE scores.

15. The method of claim 14, wherein the collaboration score is further based at least in part on one or more emotion tracking data points.

16. The method of claim 12, wherein the LOE scores are calculated by a processor of the personal electronic device.

17. A system comprising
a plurality of personal electronic devices, the plurality of personal electronic devices associated with a plurality of users;
a plurality of hardware processors associated with the plurality of electronic devices, the plurality of hardware processors configured by machine-readable instructions to:
receive video of the plurality of users during viewing or interaction of media by the plurality of users;
detect one or more participation conditions in the video, the one or more participation conditions related to one or more of speaking time, measured emotions, and level of attention associated with the plurality of users; and
for each of a plurality of time markers in the video, calculating individual LOE scores of the plurality of users with the media at the given time marker, the calculating based at least in part on the detected participation conditions.

18. The method of claim 17, wherein the LOE scores are calculated by one or more processors of the plurality of personal electronic devices.

19. The method of claim 17, wherein an aggregate LOE score is calculated at least in part by using data from the plurality of users, wherein the aggregate LOE score represents data across one or more of various genders, age groups, and ethnicities of individuals viewing the media.

20. The method of claim 19, wherein the aggregate LOE is calculated using data collected across one or more of a specified period of time or a plurality of video sessions.
